(19) United States
(12) Patent Application Publication
(10) Pub. No.: US 2010/0186422 A1
(43) Pub. Date: Jul. 29, 2010

(54) Efficient and light weight thermoelectric waste heat recovery system

(75) Inventors: Jihui Yang, Lakeshore (CA); Hsin Wang, Knoxville, TN (US); James Williams Klett, Knoxville, TN (US)

Correspondence Address: General Motors Corporation;c/o REISING ETHINGTON P.C., P.O. BOX 4390, TROY, MI, 48099-4390, US

(73) Assignees: GM GLOBAL TECHNOLOGY OPERATIONS, Detroit, MI (US); OAK RIDGE NATIONAL LABORATORY, Knoxville, TN (US)

(21) Appl. No.: 12/358,833

(22) Filed: Jan. 23, 2009

(51) Int. Cl. F25B 21/02; B60H 1/32

(52) U.S. Cl. 62/3.3; 62/239

(57) ABSTRACT

One embodiment includes an on-board thermoelectric vehicle system for generating electrical energy using a heated fluid stream, including at least one thermoelectric device having a high temperature junction and a low temperature junction, and a body of high conductivity foam shaped and located to increase heat transfer from the heated fluid stream to the high temperature junction or to increase heat transfer from the low temperature junction of the thermoelectric device.

The United States Government has rights in this invention pursuant to Cooperative Agreement No. DE-FC26-04NT42278 awarded by the United States Department of Energy. The United States Government has rights in this invention pursuant to contract no. DE-AC05-00OR22725 between the United States Department of Energy and UT-Battelle, LLC.

### TECHNICAL FIELD

This invention pertains to the use of thermoelectric devices in combination with hot fluid streams produced by an operating internal combustion engine. The high temperature sides of the devices are in heat transfer contact with, for example, the hot engine exhaust stream and the low temperature sides are in heat transfer contact with ambient air so as to produce electrical power. More specifically this invention pertains to the use of light weight, high thermal conductivity foam materials in contact with the high temperature sides and/or low temperature sides of the devices to increase their output of electrical power.

### BACKGROUND OF THE INVENTION

Improved thermal management is a leading research objective in many fields. For example, approximately 30% of the energy contained in automotive fuel may be lost to the environment as thermal energy in the exhaust gas of an internal combustion engine. It is desirable to recover a portion of this waste heat in the form of electrical power to be used in the automobile. The recovery of waste heat could reduce the power demand on the alternator of an automobile and result in improved fuel efficiency. Many aerospace and electronic applications are also seeking to improve thermal management.

Thermoelectric devices convert thermal energy into electrical energy by means of a temperature gradient. These devices have no moving parts. Therefore, thermoelectric devices are amenable to relatively low production costs in high volume and have a potential for high reliability. Thermoelectric devices may be used in recovering waste thermal energy of internal combustion engine based vehicles, for example to generate electrical power using the hot exhaust gas stream. In order to maximize the temperature gradient across the thermoelectric materials to maximize the electrical power output, it is important to have efficient heat exchangers at the hot and the cold sides of the thermoelectric devices. Therefore, there is a need for improved heat exchanger materials and design.

### SUMMARY OF THE INVENTION

A thermoelectric module may comprise two or more elements of n-type and p-type doped semiconductor material(s) that are connected electrically in series and thermally in parallel. These thermoelectric elements and their electrical interconnects often are mounted between two ceramic substrates. The thermoelectric elements are mounted with one or more junctions at a high temperature side of the module and with one or more junctions at a lower temperature side of the module. The substrates hold the overall structure together and electrically insulate individual elements from each other and from external mounting surfaces. By way of example, many thermoelectric modules range in size from approximately 2.5 to 50 mm² in area and 2.5 to 5 mm in height. In general, when the module experiences a larger temperature difference between its hot and cold junctions it produces a larger electrical output.

In many automotive vehicles a hydrocarbon fueled internal combustion engine produces a hot exhaust gas that is released through an exhaust pipe to the atmosphere. The hot exhaust gas provides a relatively high temperature source that might be exploited at the high temperature junctions of one or more thermoelectric devices. A grouping of such thermoelectric devices may, for example, be located along an exhaust gas conduit with the high temperature sides of the devices in heat exchange contact with the hot flowing gas stream. Similarly, the engine is typically cooled using a coolant liquid that is circulated within the engine and heated by it. The coolant is then circulated through a heat exchanger to release its heat to ambient air. Although a liquid coolant is at a lower temperature than combustion exhaust gas, the coolant also offers a relatively high temperature source for operation of a grouping of thermoelectric devices. In both situations, ambient air may provide the low temperature side of an interposed thermoelectric device. In order to improve the operating efficiency of a thermoelectric system that uses such a high temperature source, it is necessary to improve heat transfer at hot and cold junctions of the thermoelectric device. Such groupings or combinations of thermoelectric power generating devices may be connected for electrical current series flow and/or electrical current parallel flow to conduct generated electrical power to a battery for storage or to an electrical power consuming device on the vehicle or near a stationary engine.

This invention provides a combination of (i) a light weight, open pore, foam material with very high thermal conductivity and (ii) a thermoelectric device for improved utilization of a hot fluid stream associated with a vehicle engine (and/or a relatively cool stream of ambient air). This combination is devised to produce a high electrical output for powering an electrical device on a vehicle.

In one embodiment the high thermal conductivity foam may be carbon foam, a material formed from graphite fibers. Such a carbon material may be produced from pitch. The graphitic foam body or layer is used to increase heat transfer from a hot engine exhaust stream or a hot engine coolant stream to the high temperature side of a thermoelectric device. The foam body is designed and used to increase the temperature of the high temperature side. In another embodiment, a graphitic foam body may be used to improve heat transfer between ambient air and the low temperature side of a thermoelectric device. Again, the foam body is designed and used to decrease the temperature of the low temperature side of the thermoelectric.

Thus, the foam is used to increase the temperature difference between the hot and cold sides of the thermoelectric device so as to increase the effectiveness of the device. The high open pores of the foam permit, for example, at least some exhaust gas flow through it for improved heat transfer to the hot side of the thermoelectric device. And, likewise, the foam may permit internal ambient air flow for improved heat transfer from the thermoelectric and a lower temperature at its cold side.

The low density of the foam allows the design of effective heat transfer paths to and from the thermoelectric device(s) without adding significant weight to a vehicle.

Other objects and advantages of the invention will be more apparent from a description of illustrative embodiments of the invention which follows in this specification.

### BRIEF DESCRIPTION OF THE DRAWINGS

FIG. 1 is a schematic illustration of a thermoelectric device using p-n type conductive paths. The electrical potential producing device has a high temperature side and low temperature side with an external electrical circuit connected to the low temperature side.

FIG. 2 is a cross-sectional view of a thermoelectric waste heat recovery system at a location in an exhaust conduit for an automotive vehicle engine according to one embodiment of the invention. The illustrated system comprises an exhaust pipe from an internal combustion engine containing a porous foam through which the hot exhaust gas flows. Spaced around the hot exhaust conduit are four thermoelectric devices with their high temperature sides in contact with the hot exhaust pipe and their cold sides engaging an outer tube carrying an additional cylinder of porous carbon for improved heat conductivity to ambient air flowing past the exhaust pipe.

FIG. 3 is a thermoelectric waste heat recovery system according to another embodiment. The illustration is an axial cross-section of an exhaust pipe for a vehicle engine, showing a different design shape for the porous foam and the flow of hot exhaust gas in the conduit.

FIG. 4 is a thermoelectric waste heat recovery system according to still another embodiment. The illustration shows engine coolant and air flow paths in a heat exchanger for engine coolant. Thermoelectric devices with porous foam structures on their low temperature sides are incorporated into the air passages.

### DESCRIPTION OF PREFERRED EMBODIMENTS

One embodiment includes a thermoelectric system including high conductivity foam to convert waste thermal energy captured from a combustion engine into electrical power. The waste thermal energy may be captured from exhaust gases or coolant from the internal combustion engine. The waste thermal energy may include any thermal energy which is available after the internal combustion engine of a vehicle has performed its normal functions, such as, for example, heat remaining in the exhaust gases or heat transferred to a liquid coolant.

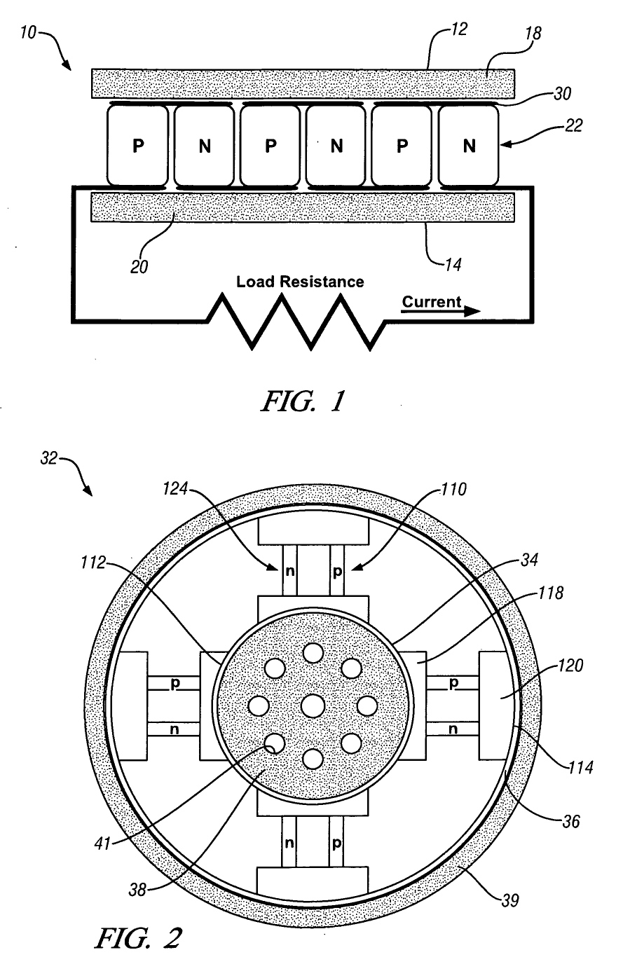

FIG. 1 shows a thermoelectric device or module 10 for producing an electrical potential and a direct electrical current. A thermoelectric device is a solid-state device with no moving parts which is capable of using a temperature differential to generate electrical power without mechanical motion. The thermoelectric device 10 includes a high temperature or hot side 12 and a low temperature or cold side 14. The high temperature side 12 is in contact with a heat source of high temperature T_{H}, and may be in part defined by a plate or substrate 18. The low temperature side 14 is in contact with a heat sink of low temperature T_{C}<T_{H}, and may be in part defined by a plate or substrate 20. The plates 18 and 20 may be made of ceramic materials that are electrical insulators and heat conductors.

In this embodiment thermoelectric device or module 10 comprises a plurality of elements of complementary thermoelectric materials indicated generally as 22 in FIG. 1. One set of thermoelectric elements are n- (negative) type semiconductor thermoelectric material (labeled N in FIG. 1) and a second complementary set of thermoelectric elements are p- (positive) type semiconductor thermoelectric material (labeled P in FIG. 1). The N semiconductor thermoelectric material is formed by adding impurities which have one more valence electron than the base semiconductor material, while the P semiconductor thermoelectric material is formed by adding impurities which have one less valence electron than the base semiconductor material. The thermoelectric device 10 may have any suitable number of N and P semiconductor thermoelectric elements, for example it may have tens or hundreds or more pairs of semiconductors N and P. As shown in FIG. 1 the thermoelectric elements are arranged with alternating pairs of N and P elements.

In the embodiment of FIG. 1, adjacent pairs of N and P thermoelectric elements are directly connected with each other electrically on one side and indirectly connected with each other through another pair of elements and the circuit on the other side. An electrical connector 30, which may be any suitable electrical interconnect material, may be used to provide an electrical conduit between any two adjacent thermoelectric N and P semiconductors. Electrons move from an n-type semiconductor thermoelectric element N to an adjacent p-type semiconductor thermoelectric element P through electrical connector 30. Two adjacent pairs of semiconductors N and P are electrically connected in series, i.e., a p-type semiconductor P of one pair is directly connected to an n-type semiconductor N of a neighboring pair or vice versa.

The complementary pairs of thermoelectric elements are in heat transfer relationship with their respective high temperature sides 12 and the low temperature sides 14. The temperature gradient between the hot side 12 and the cold side 14 causes the electrons in the thermoelectric element pairs to move away from the hot side 12 and toward the cold side 14. The electrons jump to a higher energy state by absorbing thermal energy at the high temperature side 12. The electrons flow from each pairing of n-type semiconductor N to an adjacent p-type semiconductor P through the electrical connector 30, dropping to a lower energy state and releasing energy through the low temperature side 14. An electric current is thus generated in each thermoelectric module in a direction from the n-type N to the p-type semiconductor P. As shown in FIG. 1, an external electrical circuit is connected to the low temperature side 14.

The electrical power generation is increased by increasing the temperature difference between the hot side 12 and the cold side 14, and by using thermoelectric materials 22 with larger ZT values, where ZT is the thermoelectric figure of merit. ZT is a dimensionless parameter and embodies the relationship of conversion efficiency (i.e., thermal energy to electrical energy) to material properties. ZT is conventionally defined as: ZT=S²σT/κ, where S, σ, κ, T are the Seebeck coefficient, electrical conductivity, thermal conductivity, and absolute temperature, respectively. The larger the ZT, the higher the conversion efficiency of the thermoelectric material. An efficient thermoelectric material should have a large Seebeck coefficient, high electrical conductivity, and low thermal conductivity. The thermoelectric material 22 may be, for example but not limited to, a skutterudite, Bi₂Te₃-based alloy, Zn₄Sb₃, PbSeTe/PbTe quantum dot superlattice, Bi₂Te₃/Sb₂Te₃ superlattice, AgPb₁₈SbTe₂₀, PbTe-based alloy, SiGe-based alloy, or other high efficiency thermoelectric material. The thermoelectric material 22 may be doped with impurities to form the n-type material and may be doped with impurities to form the p-type material.

In one embodiment, the source of heat that is transferred to the thermoelectric material to generate electricity is a hydrocarbon internal combustion engine (such as diesel, gasoline, and the like) that generates heated effluent. One example of heated effluent is heated exhaust gas. Another example of heated effluent is liquid coolant in a radiator. Thus, the thermoelectric device 10 may function to cool the exhaust stream or liquid coolant and convert thermal energy into electrical energy.

According to one embodiment, the temperature gradient between the hot side 12 and the cold side 14 may be increased by using a high conductivity foam material (shown in FIGS. 2-4 as 38, 39, 237, 238, 239, and 338). The foam is used to increase the temperature difference between the hot and cold sides of the thermoelectric so as to increase the effectiveness of the device. In one embodiment, the high conductivity foam material may be a carbon foam, also called graphite foam, as described in U.S. Pat. Nos. 6,033,506 and 6,037,032. The carbon foam may be formed from pitch, for example from a pitch powder, pitch granules, or pitch pellets.

Such carbon foam has extremely high thermal diffusivity and conductivity. For example, the room temperature bulk thermal conductivity of the carbon foam may range from 50 W/m·K to over 100 W/m·K. The maximum bulk thermal conductivity reported is 175 W/m·K. When weight is considered, the specific thermal conductivity of the carbon foam may be more than four times greater than the specific thermal conductivity of copper. The carbon foam also has thermal conductivity equivalent to aluminum alloys at the same volume and ⅕ of the weight of the carbon foam. The cell walls of the carbon foam are made of highly oriented graphite planes, or ligaments, similar to high performance carbon fibers. The room temperature thermal conductivity of the ligaments within the carbon foam's cell walls may be greater than 1700 W/m·K.

The porous structure and light weight nature of the carbon foam make it possible to form a direct heat exchanger. The open porous structure of the carbon foam results in a specific surface area of greater than 4 m²/g, which is more than 100 times greater than that of typical heat exchangers. The size of the pores in the carbon foam may be about 50 to 300 microns. The carbon foam also has a low density of 0.2 to 0.7 g/cm³. The unique combination of material properties also result in excellent acoustic absorption and sound damping performance (low noise). In fact, a finned heat sink made from carbon foam can be up to 3 times more efficient than an aluminum heat sink of the same volume, yet at ⅕ the weight (effectively 5 times more efficient per gram of heat sink). The maximum operating temperature of the carbon foam is 500° C. in air.

FIG. 2 shows an embodiment of a thermoelectric heat recovery system 32 including a thermoelectric device 110 for converting heat in a vehicle exhaust gas stream to electrical power. FIG. 2 is a cross-sectional view of an exhaust pipe illustrates the use of thermoelectric devices for producing electrical power. The thermoelectric device 110 may be similar to the thermoelectric device 10 of FIG. 1. In order to simplify the illustration the electrical leads from the thermoelectric devices 110 in FIG. 2 are not shown. But such electrical connections are shown in FIG. 1 and may be directed to an energy storage device such as a battery or to an electrical power consuming device.

Typically, the exhaust gas from an internal combustion engine exits the engine exhaust manifold and enters an exhaust pipe 34. The exhaust gas stream exiting the engine may have an average temperature of 500-650 degrees Celsius. The exhaust pipe 34 may include a catalytic converter, at least one silencer, and a tailpipe where the gas exits into the ambient air. The thermoelectric heat recovery system may be positioned along the exhaust pipe between the catalytic converter and the tailpipe. The thermoelectric heat recovery system 32 converts heat from the exhaust gas stream into electrical power. In one embodiment, the thermoelectric heat recovery system may extend for one to two feet along the exhaust pipe 34.

The thermoelectric heat recovery system 32 includes the thermoelectric device 110 positioned and secured between the exhaust pipe 34 and a casing or enclosure pipe 36. In one embodiment, the enclosure pipe 36 may be stainless steel. In this embodiment, the exhaust pipe 34 and the enclosure pipe 36 are round in cross-section. The exhaust pipe may be filled with porous graphite foam 38. The size of the pipe and the length of the foam 38 in the pipe 34 are devised to permit suitable exhaust gas flow without excessive back pressure. The carbon foam 38 may include passages 41 extending the length of the carbon foam 38 in the pipe 34. The exhaust gas flows through the highly thermally conductive foam and/or passages 41 in the foam to increase the temperature at the inside surface of exhaust pipe 34. The passages 41 may contribute to the maintenance of desired back pressure and better heat exchange efficiency. In various embodiments, the passages 41 may include through-thickness patterns that can be machined, carved, or cut on the carbon foam block. The passages 41 may be of any suitable shape and dimension. The passages 41 may be, for example, circular in cross-section with varying diameters. Or the passages 41 may be, for example, slits or lines that are parallel or crossing.

Any suitable number of semiconductor pairs 124 (four shown in FIG. 2) may be positioned along the outer surface of exhaust pipe 34. A hot side 112 of the thermoelectric device 110 may be located where the device touches the exhaust pipe 34. The exhaust gas flowing through the exhaust pipe 34 and foam 38 heats the hot side 112 of the thermoelectric device 110. A cold side 114 may be located where the device 110 touches the enclosure pipe 36. Air flowing past the outside of the enclosure pipe 36 cools the cold side 114. The heating of the hot side 112 and the cooling of the cold side 114 creates a temperature gradient or differential in the thermoelectric heat recovery system 32. In response to the temperature gradient, the thermoelectric heat recovery system 32 generates electrical power. The amount of electrical power generated may vary with the flow of exhaust gases from the internal combustion engine and with the type of thermoelectric material 122 used in the thermoelectric device 110.

The high conductivity foam material may be in the form of a body or layer, and may be used as a heat exchanger on the hot side and/or the cold side of the thermoelectric system 32. The foam material 38 in exhaust pipe 34 is used to increase heat transfer from a hot stream to the high temperature side 12 of the thermoelectric device 10. The foam material 38 increases the temperature of the high temperature side 12. In another embodiment, like foam material 39 may be used to improve thermal conductivity between a cold fluid, for example ambient air, and the low temperature side 14 of the thermoelectric device 10. In FIG. 2 the cylindrical layer of foam material 39 on enclosure 36 decreases the temperature of the low temperature side 114 of the thermoelectric device 110. Ambient air flows into or through foam shell layer 39.

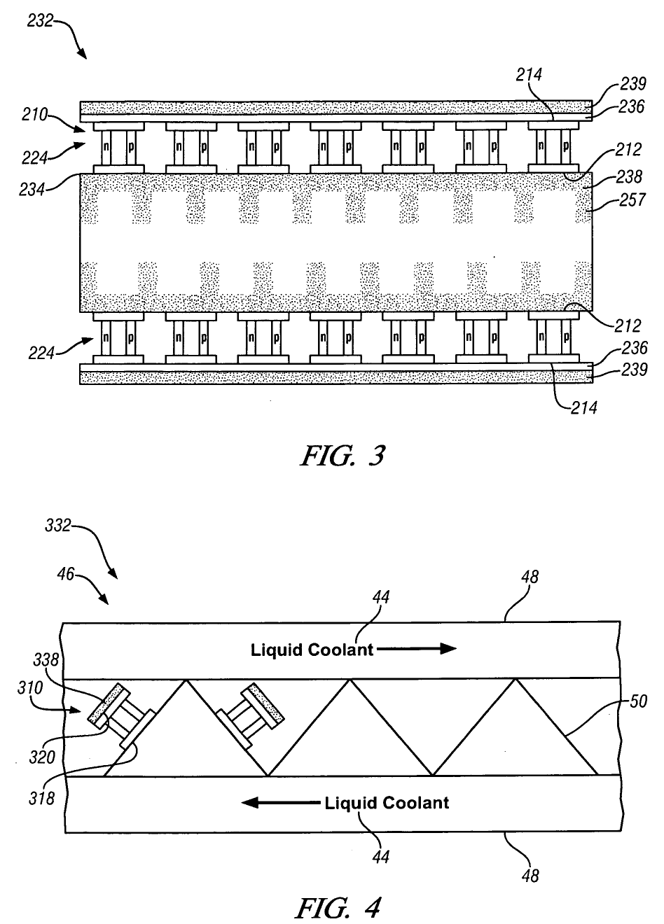

FIG. 3 illustrates another embodiment of a thermoelectric heat recovery system 232 including a thermoelectric device 210 for converting heat in a vehicle exhaust gas stream to electrical power. The thermoelectric device 210 may be similar to the thermoelectric device 10 of FIG. 1. FIG. 3 illustrates an axial cross-section of a vehicle exhaust gas conduit 234. In one embodiment, the gas conduit 234 may be stainless steel. The thermoelectric heat recovery system 232 has a different design shape for the porous foam and the flow of hot exhaust gas in the conduit than the system 32 of FIG. 2. The exhaust gas flowing through the exhaust pipe 234 heats a hot side 212 of the thermoelectric device 210. Air flowing past the outside of an enclosure pipe 236 cools a cold side 214 of the thermoelectric device 210. In the embodiment shown, there are many thermoelectric devices 210 located along the axial cross-section of the gas conduit 234 on both the hot and cold sides 212, 214. In various embodiments, there may also be numerous thermoelectric devices 210 located along the length of the gas conduit 234, upstream or downstream of the axial cross-section shown in FIG. 3. In one embodiment the porous foam, for example graphite foam, is not in the shape of a filled cylinder. Here the illustrated section of the exhaust conduit comprises a generally hollow graphite tube 238 with internal fins 237 that extend radially inwardly from the tube wall. A graphite foam portion 239 may also be positioned over the enclosure pipe 236. In this embodiment, the exhaust gas may flow perpendicular to the cross-sectional area. The exhaust gas may flow through pores of the fins 237 and tube wall to increase the outer wall temperature. Many semiconductor pairs 224 are placed and secured with their high temperature junctions pressed against the outer surface of the tube wall.

Referring to FIG. 4, in another embodiment a thermoelectric waste heat recovery system 332 recovers heat from liquid coolant streams 44 of a radiator (heat exchanger) 46. Only a fragment of the radiator 46 and its flow passages are illustrated in FIG. 4. Thermoelectric device 310 is in heat exchange relationship with the liquid coolant 44. The thermoelectric device 310 may be similar to the thermoelectric device 10 of FIG. 1. In one embodiment, the liquid coolant may be about 100° C. The radiator 46 includes tubes 48 and heat fins or foils 50. The heat fins 50 may extend between the tubes 48 in a zigzag pattern. The liquid coolant 44 flows through the tubes 48, for example aluminum tubes. The tubes 48 may be oriented horizontally or vertically. Heat is transferred from the liquid coolant 44 through the tubes 48 to the heat fins 50. In one embodiment the heat fins 50 are aluminum. Air flows past and is heated by the heat fins 50, and then the air exits the vehicle. At least one fan may be positioned on a side of the radiator 46 to keep the air flowing past the heat fins 50. The heat fins 50 increase the surface area available for heat transfer. As shown in FIG. 4, many small thermoelectric devices 310 are attached to the heat fins 50. Air flows around and through the pores of foam material 338. Pairs of semiconductors 326 may be attached to every fin 50 or to a suitable number of fins 50. A hot side 318 of each thermoelectric device 310 is secured to the heated fin surfaces of the heat exchanger, and a cold side 320 is exposed to the air flowing past the heat fins 50. The foam material 338 is designed and used to decrease the temperature of the cold side 320.

The electrical power generated by the thermoelectric heat recovery systems 32, 232, or 332 may be stored in an energy storage device. In one embodiment, the thermoelectric heat recovery system 32, 232, or 332 may be electrically connected to a thermoelectric power control system which controls the flow of electrical power from the system 32, 232, or 332 to electric power controls. An energy storage device, such as a battery or capacitors, for example, may be electrically connected to the electric power controls for the storage of electrical power generated by the thermoelectric heat recovery system 32, 232, or 332. The electrical power may then be used in the vehicle.

It is further understood that the invention encompasses thermoelectric heat recovery systems 32, 232, and 332 that recover heat released from any vehicle application. The term “vehicle” encompasses all devices and structures for transporting persons or things, including automobiles, cars, trucks, buses, motorcycles, locomotives, ships, airplanes, aerospace equipment, and the like.

The practice of the invention has been illustrated with certain embodiments but the scope of the invention is not limited to such examples.

1. An on-board thermoelectric vehicle system for generating electrical energy using a fluid stream, heated above ambient air temperature, and flowing in a heated fluid stream conduit from an internal combustion engine powering the vehicle, the heated fluid stream conduit being in heat transfer relationship with air ambient to the vehicle; the thermoelectric system comprising:
at least one thermoelectric device having at least one high temperature junction of conductive elements and at least one low temperature junction of conductive elements for producing an electrical potential when the high temperature junction and low temperature junction experience a difference in temperature, the thermoelectric device being located on the vehicle with its high temperature junction in heat transfer relationship with the heated fluid stream conduit and its low temperature junction being located in heat transfer relationship with ambient air; and
a body of high conductivity foam in heat transfer contact with at least one of the high temperature junction and the low temperature junction of the thermoelectric device, the foam body being shaped and located to increase heat transfer from the heated fluid stream to the high temperature junction or to increase heat transfer from the low temperature junction of the thermoelectric device.

2. A system as set forth in claim 1 wherein the high conductivity foam body comprises carbon foam.

3. A system as set forth in claim 2 wherein the carbon foam is formed from pitch.

4. A system as set forth in claim 1 wherein the heated fluid stream conduit is an exhaust pipe and the heated fluid stream is exhaust gas.

5. A system as set forth in claim 4 wherein the body of high conductivity foam is positioned inside the exhaust pipe.

6. A system as set forth in claim 4 further comprising a casing around the exhaust pipe and a second body of high conductivity foam, wherein the thermoelectric device is positioned on one side of the casing and the second high conductivity foam body is positioned on the other side of the casing.

7. A system as set forth in claim 6 wherein the second body of high conductivity foam comprises carbon foam.

8. A system as set forth in claim 7 wherein the carbon foam if formed from pitch.

9. A system as set forth in claim 1 wherein the heated fluid stream conduit is radiator tube and the heated fluid stream is liquid coolant.

10. A system as set forth in claim 9 further comprising at least one radiator fin and wherein the thermoelectric device and the high conductivity foam body are positioned on the radiator fin.

11. A system as set forth in claim 1 wherein the thermoelectric device comprises a thermoelectric material.

12. A system as set forth in claim 11 wherein the thermoelectric material comprises at least one of a skutterudite, Bi₂Te₃-based alloy, Zn₄Sb₃, PbSeTe/PbTe quantum dot superlattice, Bi₂Te₃/Sb₂Te₃ superlattice, AgPb₁₈SbTe₂₀, PbTe-based alloy, SiGe-based alloy, or other high efficiency thermoelectric material.

13. A system as set forth in claim 1 wherein the high conductivity foam body comprises at least one pore through which the heated fluid stream or the cold fluid stream flows.

14. A method for generating electrical energy on-board a vehicle using a fluid stream, heated above ambient air temperature, the method comprising:
providing at least one thermoelectric device having at least one high temperature junction of conductive elements and at least one low temperature junction of conductive elements, the thermoelectric device being located on the vehicle with its high temperature junction in heat transfer relationship with a heated fluid stream conduit and its low temperature junction being located in heat transfer relationship with ambient air;
flowing the heated fluid stream in the heated fluid stream conduit from an internal combustion engine powering the vehicle, the heated fluid stream conduit being in heat transfer relationship with air ambient to the vehicle;
providing a body of high conductivity foam in heat transfer contact with at least one of the high temperature junction and the low temperature junction of the thermoelectric device, the foam body being shaped and located to increase heat transfer from the heated fluid stream to the high temperature junction or to increase heat transfer from the low temperature junction of the thermoelectric device;
capturing thermal energy from the heated fluid stream using the thermoelectric device when the high temperature junction and low temperature junction experience a difference in temperature; and
converting the thermal energy into electrical power.

15. A method as set forth in claim 14 wherein the heated fluid stream conduit is an exhaust pipe and the heated fluid stream is exhaust gas.

16. A method as set forth in claim 14 wherein the heated fluid stream conduit is radiator tube and the heated fluid stream is liquid coolant.

17. A method as set forth in claim 14 wherein the body of high conductivity foam comprises carbon foam.

18. A method as set forth in claim 17 wherein the carbon foam is formed from pitch.
